(19) United States
(12) Patent Application Publication
(10) Pub. No.: US 2008/0069460 A1
(43) Pub. Date: Mar. 20, 2008

(54) METHOD FOR RECORDING A GRAPHIC DATA STREAM NOTABLY FOR COMPUTER APPLICATIONS

(75) Inventor: Eric Charpentier, Morangis (FR)

Correspondence Address: LOWE HAUPTMAN & BERNER, LLP, 1700 DIAGONAL ROAD, SUITE 300, ALEXANDRIA, VA, 22314, US

(73) Assignee: Thales, Neuilly-Sur-Seine (FR)

(21) Appl. No.: 11/857,523

(22) Filed: Sep. 19, 2007

(30) Foreign Application Priority Data
Sep. 19, 2006 (FR) 0608184

(51) Int. Cl. G06K 9/36

(52) U.S. Cl. 382/238

(57) ABSTRACT

The present invention relates to a method for recording a graphic data stream including a succession of computer images. The method includes a first step for recording the first image of the graphic data stream for each image of the graphic data stream. A second step divides a current image into blocks of pixels. A third step compares block of pixels by block of pixels, the current image and the previous image in order to obtain a set of blocks of pixels of the current image having one or more differences from the corresponding blocks of pixels of the previous image. A fourth step combines the blocks of pixels, obtained in the third step, into several sets of blocks of pixels according to a criterion of proximity. A fifth step records in a file the sets of blocks of pixels originating from the fourth combining step.

### RELATED APPLICATIONS

The present application is based on, and claims priority from, France Application Number 06 08184, filed Sep. 19, 2006, the disclosure of which is hereby incorporated by reference herein in its entirety.

### BACKGROUND OF THE INVENTION

The present invention relates to a method for recording a graphic data stream notably for computer applications in the field of air traffic control.

### DESCRIPTION OF THE PRIOR ART

The European recommendations concerning air traffic control require that the air traffic control management program is able to record the activity of the air traffic controllers in real time. All the information displayed on each controller workstation must therefore be recorded continuously, like a film. All the recorded information is then restored in the manner of a video cassette recorder so as to be able to view the situations that have for example given rise to air space management incidents such as collisions between aircraft. This restoring of information is thought of as a video playback.

Up to present, this type of recording was taken into account directly by the air traffic management program present on each controller workstation.

An air traffic control program has several functions. Amongst these functions, the air traffic management program makes it possible notably to present the air traffic controller with a certain amount of information such as the map of the region, the aircraft flight plans, the beacons, the flight paths and other information associated with the description of the air space, but also the various positions of the aircraft in flight. These items of information together form aviation data. An air traffic management program also offers functionalities making it possible to manage the various aircraft control phases such as: taking over control of an aircraft or transferring its control to another controller. The program may also supply air traffic control aid functionalities such as the detection of conflicts between aircraft which makes it possible notably to alert the controller when a safety distance between two aircraft is not observed.

In order to offer the various cited functionalities, an air traffic control program may comprise a software component for the processing and management of the aviation data and a man-machine interface hereinafter called MMI. This MMI allows the controller to view the aviation data but also to take actions such as taking over control of an aircraft. The air traffic management program also comprises a spyware application making it possible to intercept all the information passing between the data processing software component and the MMI. This spyware application then records all the data that it intercepts and the operator actions in a file. This file finally comprises a set of aviation data and operator actions that constitute a scenario that can then be played back. This method of recording and playback has many disadvantages including that of being extremely costly to apply. Specifically, each modification of an item of information sent to the MMI generates a modification of the spyware application which must also take this modification into account. Then, during test and qualification phases of the air traffic management program, it is necessary to test the processing component, then test the spyware application in order to check that the data are correctly recorded and restored. All this therefore generates considerable cost and a certain awkwardness of use. Another disadvantage of this method lies in the fact that the third party applications, coexisting on the air traffic controller workstation with the air traffic management program, cannot be the subject of a graphic recording, the spyware application being dedicated to the air traffic management program.

Another solution consists in using video recorders of the video cassette recorder type. These video machines are extremely costly and their installation is all the more costly since each controller workstation must have its own recorder. These machines furthermore have difficulty supporting the high resolutions of the source image as is the case on an air traffic control workstation: in the field of air traffic control, the usual screen resolutions are 2 048×2 048 pixels. In addition, video recorders offer very low compression ratios, which is problematic for the storage of the collected data, since up to a month of recordings made round the clock may be stored.

A third solution consists in capturing the successive images displayed on the screen and in recording this succession of static images in a standard image format while having a compression algorithm with no loss of information. However, the static compression ratio thus obtained is grossly inadequate for the requirements of the field. Specifically, the commercially available programs carrying out screen captures have insufficient compression ratios for the resolutions used in the field of air traffic control. In addition, using a commercially available program presents difficulties in the field of maintenance and upgradeability. Therefore, it is often a costly and lengthy affair to obtain upgrades when faced with new or specific requirements. This is notably critical when it involves controlling aircraft safety.

On the market, there are many video image compression programs. However, these programs use algorithms designed to process a succession of photographic images and not a succession of images originating from computer applications. The particular feature of images from computer applications is that they comprise notably text, vector lines, menus, dialogue boxes, cursors. The transition between two successive computer application images boils down mainly to sudden and localized transitions of colours or contrast, which is not the case for photographic-type images that are more prone to variations in colour shades. The commercially available algorithms currently used are suitable for processing images comprising many colours and many changes of shades in these colours. These algorithms, applied to the processing of images originating from computer applications, have a compression causing a loss of information that is unacceptable for recording the data displayed on the workstations of the air traffic controllers. With such algorithms, for example, a text restored after a compression and a decompression becomes indecipherable. In addition, the proposed compression ratios are too low for the quantity of data that has to be stored. The commercially available algorithms also have image processing times that are too long to be used on images originating from a real time application.

### SUMMARY OF THE INVENTION

A notable objective of the invention is to overcome the aforementioned disadvantages. Accordingly, the subject of the invention is a method for recording a graphic data stream consisting of a succession of computer images. The method according to the invention comprises at least the following steps:
a first step for recording the first image of the graphic data stream, and for each image of the graphic data stream:
a second step for dividing a current image into blocks of pixels,
a third step for comparing, block of pixels by block of pixels, the current image and the previous image in order to obtain a set of blocks of pixels of the current image having one or more differences from the corresponding blocks of pixels of the previous image,
a fourth step for combining the blocks of pixels, obtained in the third step, into several sets of blocks of pixels according to a criterion of proximity,
a fifth step for recording in a file the sets of blocks of pixels originating from the fourth combining step.

A division of the image may be a division of this image into a grid pattern, each block of pixels representing a square of the grid pattern.

The sets of blocks that differ from one image to the next image may be rectangles encompassing the blocks of pixels that differ from one image to the next image.

The number of rectangles being fixed, when the maximum number of rectangles is reached, the blocks of pixels differing from one image to the next image may be added to the nearest rectangle.

The intersecting or contiguous rectangles may be merged.

The block-of-pixels to block-of-pixels comparison of the two successive images is carried out by scanning the blocks of pixels linearly.

A complete image of the graphic data stream may be recorded at regular time intervals.

### BRIEF DESCRIPTION OF THE DRAWINGS

Other features and advantages of the invention will appear with the aid of the following description, given as an illustration and being non-limiting, made with respect to the appended drawings which represent:

FIG. 1, an exemplary architecture diagram of an air traffic control management program according to the prior art;

FIG. 2, an exemplary architecture diagram of an air traffic control management program according to the invention;

FIG. 3, a block diagram of an image compression algorithm according to the invention;

FIG. 4, a block diagram of the algorithm for managing the various blocks according to the invention;

FIG. 5a, an exemplary comparison of two video images using the method according to the invention;

FIG. 5b, an exemplary grouping of various blocks according to the invention;

FIG. 5c, an exemplary recording of an image using the method according to the invention;

FIG. 6, an exemplary file format describing an image recorded using the method according to the invention.

### DETAILED DESCRIPTION OF A PREFERRED EMBODIMENT

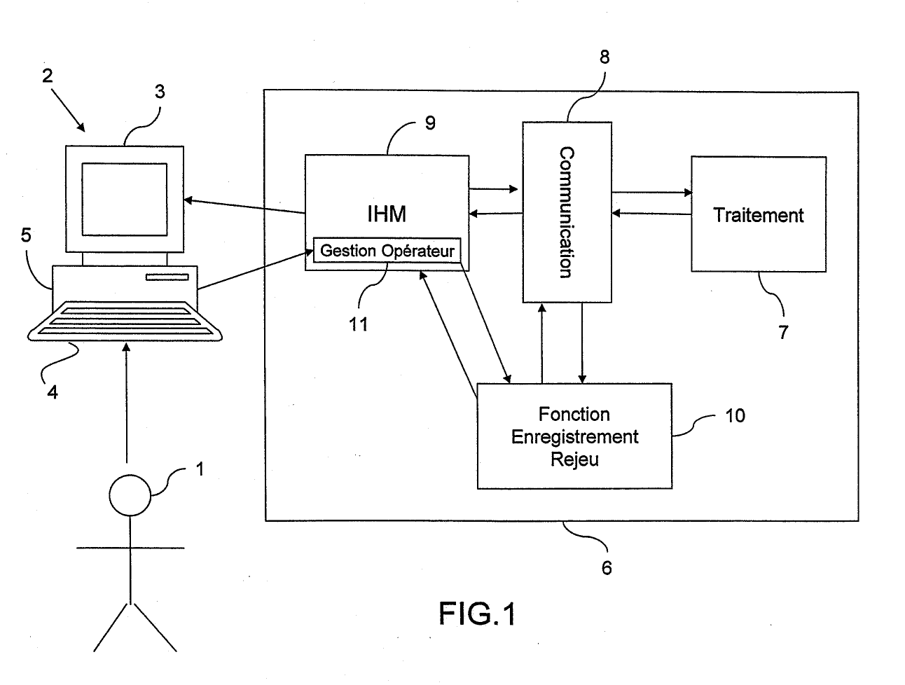

FIG. 1 shows a schematic view of an exemplary architecture of an air traffic control management program according to the prior art. FIG. 1 shows: an operator 1, who may be an air traffic controller, and his workstation 2 comprising a screen 3, an input device 4 that may comprise for example a mouse and a keyboard, and a central processor unit 5 on which the air traffic management program 6 runs.

The air traffic management program 6 comprises several software components. To simplify the description, “software component” is called simply “component”. Amongst these software components there are:
an aviation data management and processing component 7,
a communication component 8,
an MMI component 9 and
a component 10 called a “record-playback function”.

The component 10 allows the data displayed thanks to the MMI 9 to be recorded, in the form of a scenario, and the recorded scenario to be played back by restoring the data to the MMI 9.

The processing component 7 is notably responsible for managing all the aviation data. Amongst these data there are the data describing the air space such as the beacons, check-points, the air lanes and the zones to be avoided. The aviation data also comprise all the data concerning the aircraft such as their flight plan, their altitude, their position, and the control information concerning the aircrafts. The processing component 7 also manages the map data such as the airports, the towns, the coasts and the frontiers. This component 7 also supplies the operator with aircraft control management functionalities allowing, for example, the controller to take over control of an aircraft. The controller may also modify the data of an aircraft flight plan according to trajectory modification instructions that he gives to the aircraft. This processing component 7 also makes it possible to offer the controller control help tools such as a function for detecting conflicts between two aircraft trajectories, a function for detecting proximity between two aircraft. The controller may therefore anticipate potentially dangerous situations by giving instructions to one of the two aircraft to divert for example.

All the data managed by the processing component 7 are sent to the MMI 9 by the communication component 8. This component 8 also allows the record-playback function 10 to recover all the data passing between the processing component 7 and the MMI 9 in order to record them for the purpose of a future playback.

The MMI component 9 allows the data received from the processing component 7 to be displayed on the screen 3 in order to be viewed by the controller 1.

The controller 1, in the context of his air traffic management function, takes actions like opening a window on the screen, selecting a displayed object or else entering data thanks to the device 4. These actions or data entries are processed in the MMI 9 by an operator management component 11. The MMI then transmits the data corresponding to the entry or to an operator action to the processing component 7 by means of the communication component 8. The record-playback function 10 also records all the data corresponding to the actions and data entries of the controller in order to be able to play them back later.

The record-playback function 10 has two operating modes: a recording mode when the air traffic control management program is running and another mode for restoring the recorded data when a work sequence of the controller is played back. During the playback, the processing component 7 is therefore inactive and the inputs coming from the device 4 are ignored: all the data displayed on the screen 3 come from the record-playback function 10 via the communication component 8 and the MMI 9.

The data collected by the record-playback function 10 are stored in a file that will be re-read by the function 10 in data restore mode. The data recording format therefore depends on the data transfer format defined for the communication component 8. Each time a data item is added or each time the transfer format is changed, the recording format must be modified: the record-playback function 10 is also modified. The changes to the record-playback function of the air traffic control management program 6 are therefore considerable and costly to apply and test.

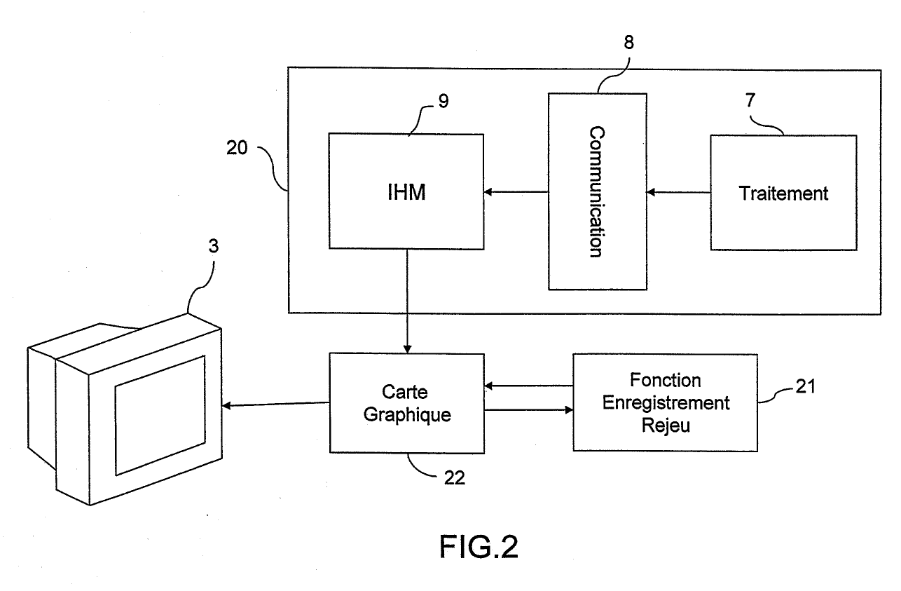

FIG. 2 shows another architecture of an air traffic control management program 20 according to the invention. The air traffic control management program still comprises a processing component 7, a communication component 8 serving as an interface between the processing component 7 and the MMI component 9. The MMI component 9 still makes it possible to display on a screen 3 the information that it receives. The interactions of the program with the operator have not been shown in FIG. 2 because they are not necessary to the presentation of the architecture used by the record-playback function 21. The interactions between the operator and the program are the same as those described in FIG. 1.

In order to display the air traffic information on the screen 3, the MMI 9 uses a graphics card 22. The method according to the invention judiciously uses an architecture which consists in recovering the data passing through the graphics card 22. These data are the images to be displayed on the screen 3. A record-playback function 21 is therefore directly connected to the graphics card 22 in order, at regular intervals, to recover and record the images displayed in a file. The images thus recorded are re-sent by the record-playback function 21 to the graphics card 22 in order to be displayed on the screen 3 when the record-playback function is in data restore mode. Recovering the data constituting each image directly from the graphics card 22 makes it possible to record all the data displayed on the screen of the controller, and notably the actions of the controller like the movement of his cursor or else the opening of a window.

This architecture makes it possible to dispense with the specific format of the processed data in order to concentrate uniquely on the resultant image displayed on the screen. This therefore makes it possible to make the record-playback function 21 independent of the air traffic control management program 20. The record-playback function is then not affected by any changes to the air traffic control management program. In addition, it may also record data from a third party application such as a word processor for example.

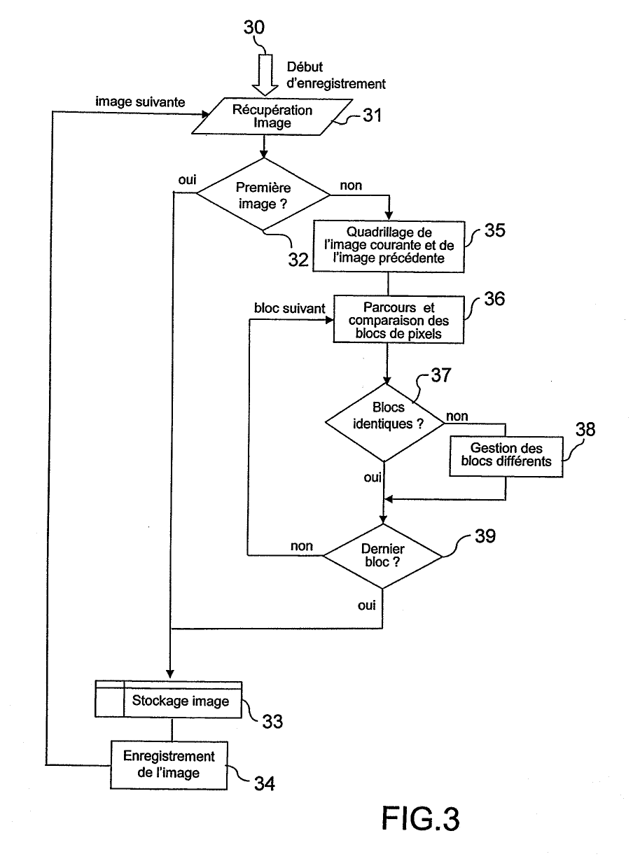

FIG. 3 shows an example of the various steps of an image compression and storage algorithm according to the invention. The record-playback function 21 therefore recovers an image from the graphics card and then compresses and subsequently stores the image in a data file by running an algorithm according to the invention. This algorithm uses an iterative method, each iteration corresponding to the recognition of a new image to be processed then to be recorded in a file.

At the start of recording 30, the record-playback function 22 receives a first image in a first image recovery step 31. Then, in a second step 32, the algorithm tests whether this image is the first or not.

In the case of a first image of the image stream, this image is saved in memory during a storage step 33 so that it can be compared with the next image. Then this image is recorded in a file during a recording step 34. Once recording is finished, the algorithm returns to the image recovery step 31 in order to obtain the next image.

If the current image is not the first image of the stream, this image is then directly divided into several blocks of pixels. This division may be carried out by dividing the image into a grid pattern 35 of squares 32 pixels by 32 pixels. The size of the squares of the grid pattern can be programmed according to the size of the images to be processed in order to optimize the image processing time for example. Each square of the grid pattern thus obtained therefore represents a block of pixels of the image. If the previous image has not been divided, a grid pattern of this image is made in the same manner as previously described. The set of blocks of pixels is then scanned during a step 36 in order to compare, block by block, the current image and the previous image. The division of the images remains constant from one image to the next in order to be able to make the block-by-block comparison.

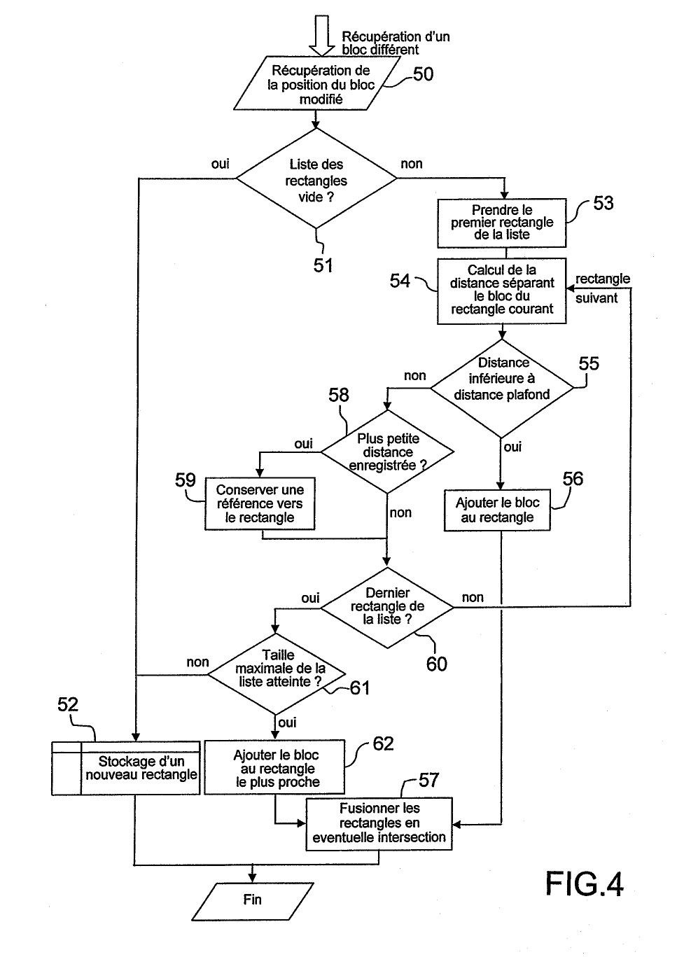

If the two compared blocks are not identical, the “blocks identical” condition 37 is not fulfilled and therefore the current block of the current image is transmitted to a different-block management algorithm shown in FIG. 4.

If the blocks are identical, the algorithm moves on to the next block and so on until the condition 39 of reaching the last block of the current image is verified. When the current image has been entirely scanned by the algorithm, it is stored in memory during a step 40 in order to be compared with the next image. Then, in another step 41, only the blocks of the current image that have shown a difference from the blocks of the previous image are recorded in the file. Then the algorithm moves on to the next image and does so until the recording is stopped.

The present algorithm therefore makes it possible to carry out a dynamic compression, in the sense that it depends on the number of different blocks discovered in the image being processed. This makes it possible to reduce the quantity of information to be recorded.

FIG. 4 represents an algorithm for managing the different blocks according to the invention. A different block is a square of the current image that has differences from a square of the previous image positioned in the same location and having the same dimensions as the square of the current image. The general principle of this algorithm is to construct rectangles encompassing different blocks. The number of rectangles thus constructed is limited in order to optimize data storage and the computing time necessary to compare two images.

When the algorithm represented in FIG. 3 finds a different block, it then calls a different-block management algorithm 38, shown in FIG. 4. In a first step 50, the different-block management algorithm recovers the position of the different block. Then the algorithm, in a second step 51, recovers a list of rectangles already formed. In this list, each rectangle is a rectangle encompassing a set of different blocks of the image. A rectangle therefore represents a portion of the image.

If the list of rectangles is empty, the third step 52 consists in producing a first rectangle comprising only the new different block. This new rectangle is then stored in the list of rectangles.

If the list of rectangles is not empty, the algorithm recovers the first rectangle from the list during a fourth step 53; the first rectangle then becomes the current rectangle. A subsequent fifth step 54 is to compute the distance separating the different block from the current rectangle. This distance expressed in number of pixels is then compared, during a sixth step 55, with a ceiling distance beyond which it is considered that the criterion of proximity between the rectangle and the different block is not satisfied. This distance may be of the order of one pixel for example.

If the criterion of proximity is satisfied, the different block is added, during a seventh step 56, to the current rectangle whose geometry is recomputed in order to contain the added block. The geometry of the rectangle is redefined in order to encompass the initial rectangle plus the added block. Then the algorithm scans all the stored rectangles in order to merge the intersecting or contiguous rectangles in an eighth step 57. Two rectangles are merged by constructing a third rectangle encompassing the first two rectangles. The rectangle thus constructed then replaces the first two rectangles in the list of rectangles.

If the criterion of proximity is not observed, a subsequent ninth step 58 makes it possible to compare the distance with a recorded distance. If this distance is the smallest of the recorded distances, the algorithm retains a reference to the current rectangle in a tenth step 59. In both cases, the algorithm then moves on to an eleventh step 60 making it possible to iterate on the rectangles of the list.

If the last rectangle of the list has not been reached by the algorithm, the algorithm then returns to the fifth step 54 for computing the distance separating the current different block from the next rectangle that then becomes the current rectangle.

If the last rectangle has been reached and tested, the algorithm verifies, during a twelfth step 61, whether the maximum size of the list of rectangles has been reached. If this is the case, it means that the maximum number of rectangles has been reached. This maximum number of rectangles may be for example of the order of five rectangles. The number of rectangles is intentionally reduced in order to limit the time for recording the latter in the file.

If the maximum number of rectangles has been reached, in a subsequent thirteenth step 62, the algorithm recovers the reference of the rectangle closest to the current different block, retained during the tenth step 59, in order to add the current different block to the rectangle indicated by the recorded reference. Then comes the eighth step 57 for merging any rectangles that are intersecting.

If the maximum number of rectangles has not been reached, a new rectangle is formed with the current different block, like during the third step 52. This new rectangle is then stored in the list of rectangles.

The rectangles thus formed therefore represent a differential between the previous image and the current image. Only the image portions contained in the rectangles are therefore recorded, in order to limit the storage size of each image. The current image is then reconstituted during the playback based on the previous image and the rectangles of the current image.

This algorithm therefore makes it possible to optimize the time necessary to record an image but also to optimize the size of each recorded image.

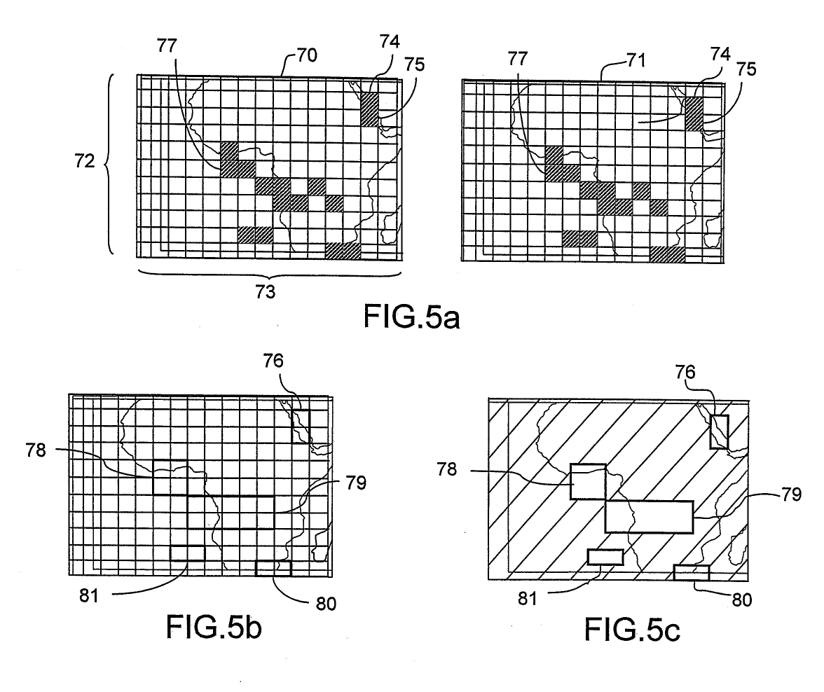

FIGS. 5a, 5b and 5c represent an exemplary constitution of the rectangles that are recorded instead of the complete image. FIG. 5a shows a first image 70 and a second image 71. The second image 71 is considered to be the current image to be recorded. The two images are divided into the form of a grid pattern. The grid pattern is shown in the form of n lines 72 of m blocks 73 each. The algorithm scans each line of blocks, beginning with the top of the image and for each line the algorithm scans the blocks from left to right, for example. The different block detection algorithm, shown in FIG. 3, has identified in this example a first block 74 having pixels that differ between the two images 70, 71. A first rectangle is therefore formed comprising only block 74. By scanning the second line of the grid pattern, the different block detection algorithm identifies a second block 75 comprising differences between the two images 70, 71. This second block 75 being contiguous with the first rectangle formed only of the first block 74, the second block 75 is added to the first rectangle forming a rectangle 76 shown in FIG. 5b. By scanning the rest of the grid pattern in the same manner, the algorithm discovers three other different blocks, then forming a second rectangle 78. And so on until the grid pattern is completely scanned by the algorithm. This produces, for example, five rectangles 76, 78, 79, 80, 81 representing the differences between the first image 70 and the second image 71. The portions of the second image contained in the rectangles 76, 78, 79, 80, 81 shown in FIG. 5c are then recorded in a data file in the form of five images.

The linear scan, from left to right and then from top to bottom, of the grid pattern allows a rapid scan through each image and therefore makes it possible to obtain a capability to record approximately five images per second. This result is sufficient to allow a satisfactory viewing, with respect to the requirements relating to the air traffic control field, of the scenario during the playback.

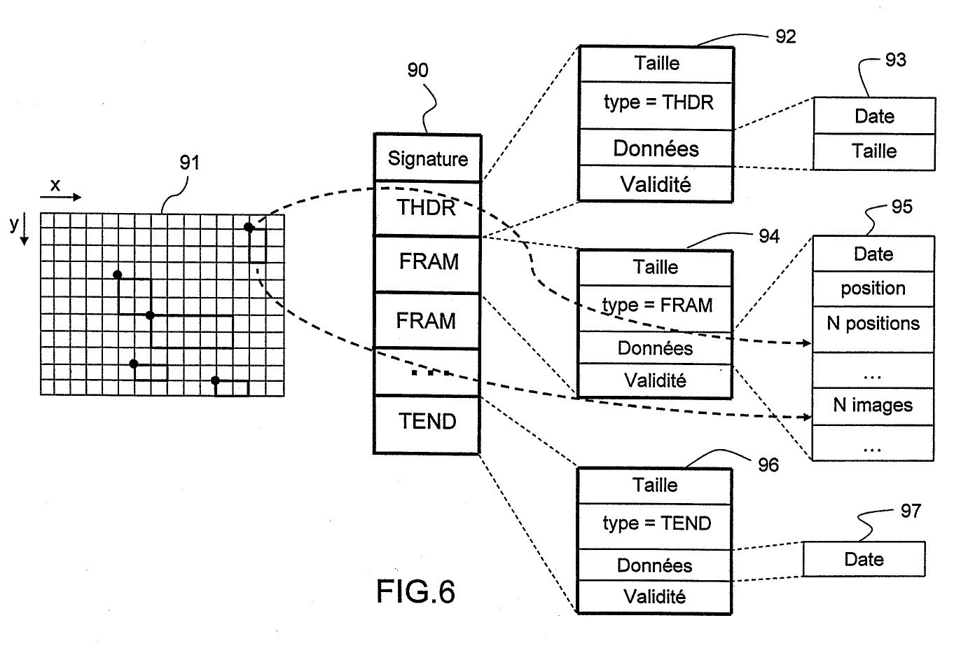

FIG. 6 represents an exemplary structure 90 of a data file used to record an image 91 using the method according to the invention. The data structure 90 describing the image may comprise:
a message signature that makes it possible to name the data format used in order to be able to read this file with a dedicated application, in our example the signature may be “TMNG”,
a first segment named THDR making it possible to store general information on the recorded images,
several segments named FRAM, each of them containing for example a description of the recorded image,
a segment named TEND containing for example an end-of-recording time.

Each segment THDR, FRAM, TEND may have the same basic structure comprising:
a segment size,
a type of segment that may be for example THDR, FRAM or TEND,
the data specific to each type of segment, and
a field making it possible to check the validity of the data contained in the segment in order to detect any corruption of the latter during encoding or decoding.

The first segment THDR has a structure 92 that allows it to store, in the “Data” portion 93, a time that may be a time relating to the recording start time in order to be able to synchronize the video playback with a voice recording for example. The “Data” portion 93 of the segment THDR also makes it possible to store a size that may be the size of the screen for example.

The segments FRAM each have a structure 94 making it possible to store the image compressed by the algorithm according to the invention previously described. The “Data” portion 95 of a segment FRAM may notably contain a time, a position which may be the position of the cursor on the image, and N positions followed by N images which correspond to the N rectangles obtained by the algorithm described in FIG. 4. Each of the N positions corresponds to the position of the top left corner of each of the N rectangles. Each position is indicated by its coordinates (x, y), y representing the abscissa and x representing the ordinate of the top left corner of the rectangle, the reference being situated in the top left corner of the image 91. The units used are the length and the width of a cell of the grid pattern of the image 91. Each image is recorded in a standard image format making it possible to carry out an additional compression of the recorded data. The time specified at the beginning of each segment FRAM corresponds to the time at which display of the image described by the segment FRAM in question starts. An image remains displayed up to the display time of a subsequent image.

An entire image, that is to say a segment FRAM 94 comprising a single position (0,0) and a single image, is recorded at regular intervals. This makes it possible judiciously to begin a playback from a moment after the recording start time, a complete image being necessary for playback to start. This also makes it possible to alleviate any recording problem.

The third segment TEND has a structure 96 which makes it possible notably to specify the end of the description of the image 91. This segment may notably contain, in the “Data” portion 97 that is specific thereto, a time, relative to the recording start time, representing the recording end time.

The data format used in order to store the various images therefore makes it possible to play back a scenario comprising successive images in the manner of a film.

The method according to the invention may, where necessary, be synchronized with sound data in order to restore, during playback, the conversation between the controller and the crew of an aircraft for example.

The method according to the invention may be used on any workstation, requiring a record and playback function, irrespective of the application. The method according to the invention may for example be used on telecommunications network supervision stations.

The main advantage of the method according to the invention is that it is independent of the data to be recorded and restored. Accordingly it is inexpensive to develop and maintain in operating condition and also has the advantage of being able to record any type of data originating from any graphics application.

The method according to the invention advantageously has results in the matter of compression ratio, information integrity and processing time that perfectly suit the requirements of the field of air traffic control. Specifically, the method according to the invention is simple enough to allow an on-the-fly comparative analysis of the successive images while retaining a reduced computing time consumption by the processor, notably for large-sized images such as images 2048 pixels by 2048 pixels. In addition, the method according to the invention is sufficiently precise and suited to computer images as not to lose information, while retaining a considerable compression factor.

The method according to the invention is notably suitable for recording and playing back an air traffic management program, given that it can take account of high resolution images while retaining a good image quality when restored.

1. A method of recording a graphic data stream including a succession of computer images comprising the following steps:
a first step for recording the first image of the graphic data stream, and for each image of the graphic data stream:
a second step for dividing a current image into blocks of pixels,
a third step for comparing, block of pixels by block of pixels, the current image and the previous image in order to obtain blocks of pixels of the current image having one or more differences from the corresponding blocks of pixels of the previous image,
a fourth step for combining the blocks of pixels, obtained in the third step, into several rectangles encompassing the blocks of pixels according to a criterion of proximity, and
a fifth step for recording in a file the rectangles encompassing the blocks of pixels originating from the fourth combining step.

2. The method according to claim 1, wherein the division of the image is a division of this image into a grid pattern, each block of pixels representing one square of the grid pattern.

3. The method according to claim 1, wherein the number of rectangles being fixed, when the maximum number of rectangles is reached, the blocks of pixels differing from one image to the next image are added to the nearest rectangle.

4. The method according to claim 1, wherein the intersecting or contiguous rectangles are merged.

5. The method according to claim 1, wherein the block-of-pixels to block-of-pixels comparison of the two successive images is carried out by scanning the blocks of pixels linearly.

6. The method according to claim 1, wherein a complete image of the graphic data stream is recorded at regular time intervals.
